(19) United States
(12) Patent Application Publication
(10) Pub. No.: US 2005/0234710 A1
(43) Pub. Date: Oct. 20, 2005

(54) Canceling a speech interaction session

(75) Inventors: Stephen Russell Falcon, Woodinville, WA (US); David Julian Hetherington, Redmond, WA (US)

Correspondence Address: LEE & HAYES PLLC, 421 W RIVERSIDE AVENUE SUITE 500, SPOKANE, WA, 99201, US

(73) Assignee: Microsoft Corporation

(21) Appl. No.: 10/828,912

(22) Filed: Apr. 20, 2004

(51) Int. Cl. G10L 21/00

(52) U.S. Cl. 704/200

(57) ABSTRACT

Systems and method for canceling a speech interaction session are disclosed. In one exemplary implementation a method of canceling a speech interaction session, comprises receiving a signal indicating that a predetermined switch has been set to a first state, monitoring a time parameter indicative of the time the switch remains in the first state, and canceling the speech interaction session if the time parameter exceeds a threshold.

### TECHNICAL FIELD

The systems and methods described herein relate to speech systems, and more particularly to canceling a speech interaction session.

### BACKGROUND

Computer operating systems and user interfaces associated with them have evolved over several years into very complex software programs that are difficult to learn, master and thereby leverage the full potential of the programs. Many operating systems include a speech interface for people to communicate and express ideas and commands.

Most operating systems that utilize a speech interface provide a low-level interface that allows speech-enabled applications to work with the operating system. Such a low level interface provides basic speech functionality to the speech-enabled applications. Consequently, each speech-enabled application must provide a higher level of interface to a user. As a result, each speech-enabled application may be different from other speech-enabled applications from the user's perspective. The user may have to interact differently with each speech-enabled application. This makes it difficult for the user to work with multiple speech-enabled applications and limits the user's computing experience.

In addition, speech interaction systems may permit users to initiate an interaction session using electromechanical mechanisms such as, e.g., pushing a button, or by making a spoken request to the system to initiate a session. Most speech interaction systems require a user to terminate by issuing a voice command such as, e.g., “cancel”, “goodbye”, or “finished”. Alternate mechanisms for terminating a session are desirable.

### SUMMARY

Described herein are systems and methods for canceling a speech interaction session. The systems and methods permit a speech interaction session to be canceled using physical mechanisms such as, e.g., pressing a button on a keyboard or an electronic device for a predetermined time period or according to a predetermined sequence.

In an exemplary implementation a method of canceling a speech interaction session is provided. The exemplary method comprises receiving a signal indicating that a predetermined switch has been set to a first state; monitoring a time parameter indicative of a time the switch remains in the first state; and canceling the speech interaction session if the time parameter exceeds a threshold.

### BRIEF DESCRIPTION OF THE DRAWINGS

FIG. 1 is a block diagram of an exemplary speech interaction system.

FIG. 2 is a schematic illustration of an exemplary speech interaction system including an exemplary operating environment.

FIG. 3 is a flowchart illustrating operations in an exemplary method for canceling a speech interaction session.

FIG. 4 is a flowchart illustrating further operations in an exemplary method for canceling a speech interaction session.

FIG. 5 is a flowchart illustrating operations in another exemplary method for canceling a speech interaction session.

FIG. 6 is a flowchart illustrating further operations in another exemplary method for canceling a speech interaction session.

FIG. 7 is a diagram of an exemplary computing system in which the present invention may be implemented.

### DETAILED DESCRIPTION

Described herein are exemplary system and methods for canceling a speech interaction session. The methods described herein may be embodied as logic instructions on a computer-readable medium. When executed on a processor, the logic instructions cause a general purpose computing device to be programmed as a special-purpose machine that implements the described methods. The processor, when configured by the logic instructions to execute the methods recited herein, constitutes structure for performing the described methods.

Exemplary Speech System

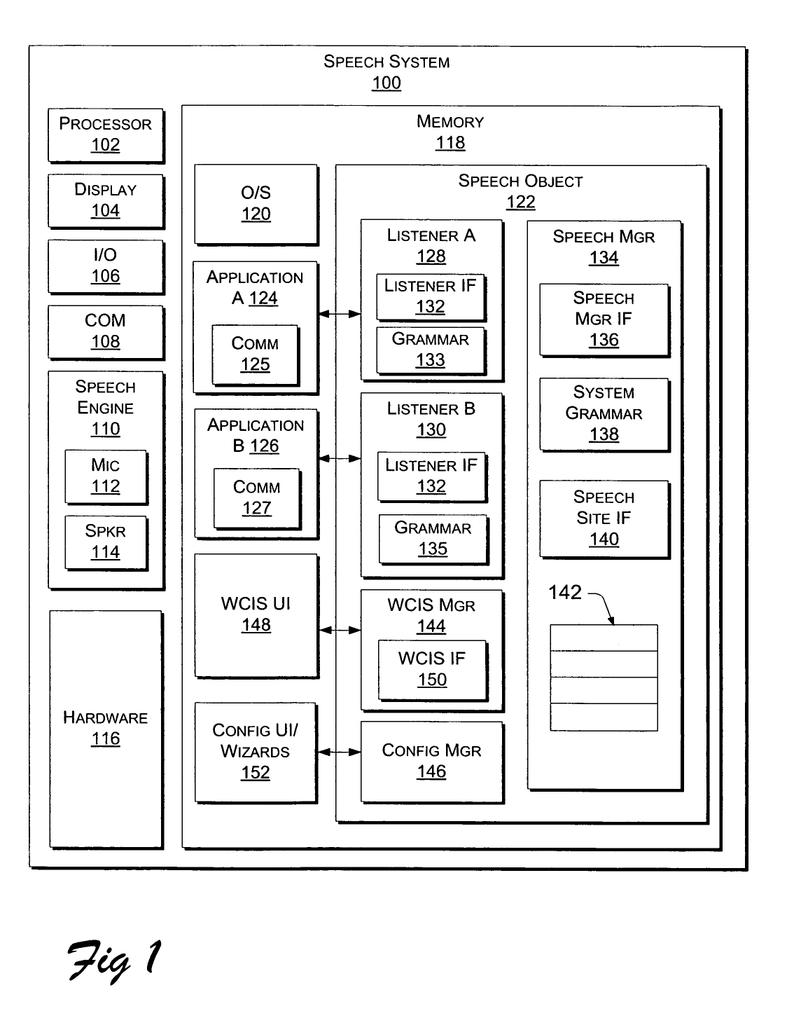

FIG. 1 is a block diagram of a speech system 100 constructed in accordance with the present description. The speech system 100 includes a processor 102, a display 104, and input/output (I/O) module 106 and a communications module 108. The I/O module 106 is used to control communications with external hardware items (not shown) such as a printer and/or a scanner. The communications module 108 is used to control communications with one or more other systems via a network, such a local area network (LAN) or the Internet.

The speech system 100 further includes a speech engine 110 that has an input device such as a microphone 112 and an output device such as a speaker 114. Various other hardware components 116 utilized by the speech system 100 but not specifically mentioned herein are also included.

The speech system 100 also includes memory 118 typically found in computer systems, such as random access memory (RAM). The memory 118 stores an operating system 120. A speech object 122 that is stored in the memory 118 is shown separate from the operating system 120. However, it is noted that the speech object 122 and its components may also be a part of the operating system 120.

The memory 118 may store a first speech-enabled application, Application A 124 and a second speech-enabled application, Application B 126. Application A 124 is associated with a first listener object, Listener A 128 and Application B 126 is associated with a second listener object, Listener B 130. Listener A 128 includes a listener interface 132 by which Listener A 128 communicates with the speech object 122. Listener A 128 also includes a listener grammar 133 that is a unique speech grammar local to Listener A 128. Listener B 130 also includes the listener interface 132 through which Listener B 130 communicates with the speech object 122. Listener B 130 also includes a listener grammar 135 that is a unique speech grammar local to Listener B 130.

Application A 124 includes a communications path 125 that Application A 124 utilizes to communicate with Listener A 128. Similarly, Application B 126 includes a communications path 127 that Application B 126 utilizes to communicate with Listener B 130. The communication paths 125, 127 may comprise a common interface between the speech-enabled applications 124, 126 and the listener objects 128, 130, or they may comprise a private communication path accessible only by the respective speech-enabled application 124, 126 and listener object 128, 130. The communication paths 125, 127 may remain inactive until the speech-enabled applications 124, 126 activates the communications paths 125, 127 and requests attention from the corresponding listener object 128, 130. Additionally, the communication paths 125, 127 may provide one-way communication between the speech-enabled applications 124, 126 and the listener objects 128, 130 or they may provide two-way communications.

A speech manager 134 is stored in the memory 118 and is the main speech desktop object. It controls the main thread of the speech object 122. The speech manager 134 is used to control communications with the listener objects including dispatching appropriate events. The speech manager 134 exposes a speech manager interface 136 to speech-enabled applications and a speech site interface 140. A system grammar 138 is included in the speech manager 134 and provides a global speech grammar for the speech system 100. A listener table 142 stored in the speech manager 134 maintains a list of currently loaded and executing listeners (in this example, Listener A 128 and Listener B 130).

The speech object 122 also includes a “What Can I Say?” (WCIS) manager 144 and a configuration manager 146. The WCIS manager 144 provides access to a “What Can I Say?” (WCIS) user interface 148 and includes a Speech WCIS interface 150 that the WCIS manager 144 uses to communicate with the speech object 122.

It is noted that the elements depicted in FIG. 1 may not all be required to provide the functionality described herein. Furthermore, additional elements may be included in the speech system 100 without impeding the functionality described herein. The elements shown may also be grouped differently than shown in FIG. 1, so long as the alternative grouping does not significantly alter the functionality as described. The elements previously described and their related functionality will be described in greater detail below.

Speech Manager Interface

As previously noted, the speech manager 134 exposes the speech manager interface 136 to one or more speech-enabled applications, such as Application A 124 and Application B 126. The following discussion of the speech manager interface 136 refers to the speech manager interface 136 as (interface) ISpDesktop 136. ISpDesktop 136 is the nomenclature utilized in one or more versions of the WINDOWS family of operating systems provided by MICROSOFT CORP. Such a designation in the following discussion is for exemplary purposes only and is not intended to limit the platform described herein to a WINDOWS operating system

The following is an example of the ISpDesktop 136 interface.

Interface ISpDesktop

```
{
    HRESULT Init( );
    HRESULT Run(
          [in] BOOL fRun);
    HRESULT Configure([in] BOOL fConfigure);
    HRESULT WhatCanISay(
          [in] BOOL fRun);
    HRESULT Shutdown( )
};
```

The “Init” or initialization first sets up the listener connections to the speech recognition engine 110. Once this connection is established, each listener object that is configured by the user to be active (listeners can be inactive if the user has decided to “turn off a listener” via the configuration mechanism) is initialized via a call to the ISpDesktopListener::Init( ) method. The listener object is given a connection to the speech engine 110 to load its speech grammars and set up the notification system.

The “Run” method activates and/or deactivates the speech system 100 functionality. The “Run” method is typically associated with a graphical user interface element or a hardware button to put the system in an active or inactive state.

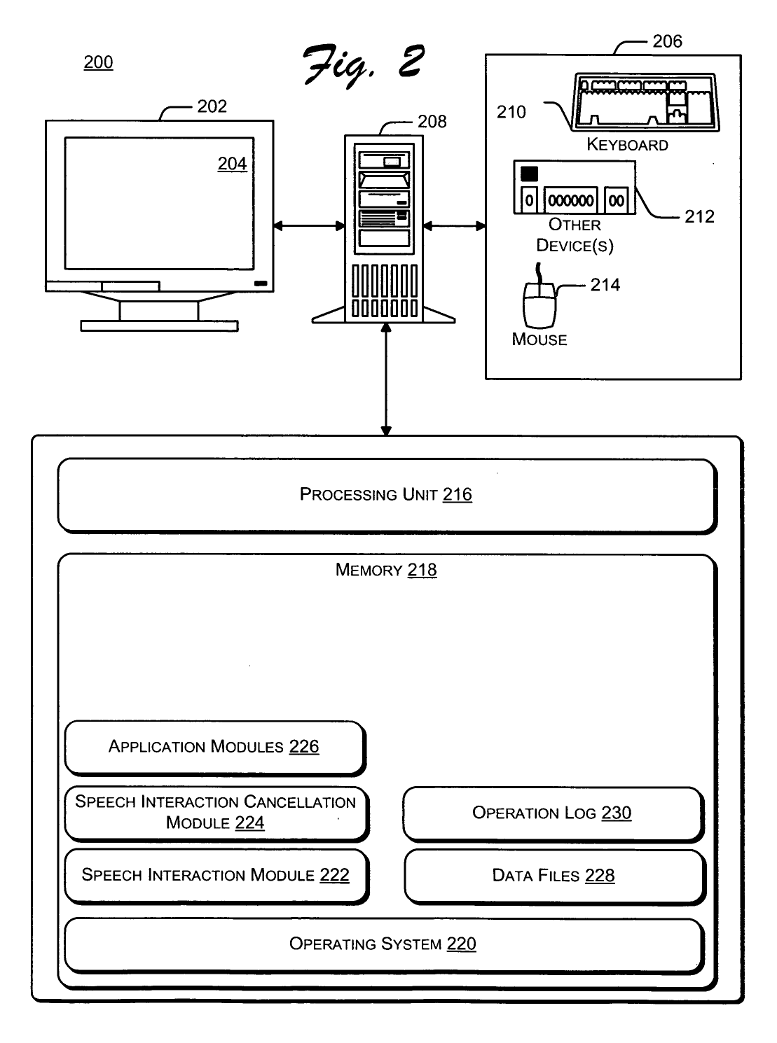

The “Configure” method instructs the speech system 100 to display the configuration user interface 152, an example of which is shown in FIG. 2 and discussed in detail below. Similarly, the “WhatCanISay” method instructs the speech system 100 to display a “What Can I Say?” user interface 148, an example of which is shown in FIG. 2 and discussed in detail below. The “Shutdown” method is utilized to shut down the speech system 100.

Listener Interface

As previously noted, each listener object 128, 130 in the speech system 100 exposes the listener interface 132. An exemplary listener interface 132 is shown and described below. The following discussion of the listener interface 132 refers to the listener interface 132 as (interface) ISpDesktopListener 132. ISpDesktopListener 132 is the nomenclature utilized in one or more versions of the WINDOWS family of operating systems provided by MICROSOFT CORP. Such a designation in the following discussion is for exemplary purposes only and is not intended to limit the platform described herein to a WINDOWS operating system

The following is an example of the ISpDesktopListener 132 interface.

Interface ISpDesktopListener

```
{
    HRESULT Init(
ISpDesktopListenerSite * pSite,
ISpRecoContext * pRecoCtxt);
    HRESULT Suspend( );
    HRESULT Resume( );
    HRESULT OnFocusChanged(
        DWORD event,
        HWND hwndNewFocus,
        LONG idObject,
        LONG idChild,
        const WCHAR **ppszFocusHierarchy);
    HRESULT WhatCanISay(
        [in] DWORD dwCookie,
[in] ISpWCIS * pSite;
};
```

The “Init” method transmits a recognition context (to add to speech grammars) (i.e., ISpRecoContext*pRecoCtxt) and the site to communicate back to the speech system 100 (i.e., ISpDesktopListenerSite*pSite). Each listener object 128, 130 performs their own initialization here, typically by loading or constructing their respective speech grammars.

The “Suspend” method notifies the listeners 128, 130 that the speech system 100 is deactivated. Conversely, the “Resume” method notifies the listeners 128, 130 that the speech system 100 is activated. The listeners 128, 130 can use this information to tailor their particular behavior (e.g., don't update the speech grammars if the speech system 100 is not active).

The “OnFocusChanged” method informs a particular listener 128, 130 that a new speech-enabled application 124 has focus (i.e., a user has highlighted the new speech-enabled application 124). The listener 128 associated with the newly focused speech-enabled application 124 uses this information to activate its grammar. Conversely, a previously active listener (e.g., Listener B 130) that loses focus when focus changes to the newly focused speech-enabled application 124 uses the information to deactivate its grammar.

The “What Can I Say” method is used for the WCIS Manager 144 to notify each listener 128, 130 that a user has requested the WCIS user interface 148 to be displayed. As previously mentioned, the WCIS user interface 148 is shown in FIG. 2 and will be described in greater detail below. The listeners 128, 130 use the ISpWCIS pointer given to them via the WhatCanISay( ) method to provide their WCIS information to the WCIS manager 144 to be displayed on the display 104. The listeners use the dwCookie value to identify themselves if they need to update the information.

WCIS Interface

The “What Can I Say?” (WCIS) interface 150 is implemented by the What Can I Say? user interface 148 and is used by the listeners 128, 130 to update their WCIS information in that dialogue. An exemplary WCIS interface 150 is shown and described below. The following discussion of the WCIS interface 150 refers to the WCIS interface 150 as (interface) ISpWCIS 150. ISpWCIS 150 is the nomenclature utilized in one or more versions of the WINDOWS family of operating systems provided by MICROSOFT CORP. Such a designation in the following discussion is for exemplary purposes only and is not intended to limit the platform described herein to a WINDOWS operating system

The following is an example of the ISpWCIS 150 interface.

Interface ISpWCIS

```
{
    HRESULT UpdateWCIS(
          [in] DWORD dwCookie,
          [in] SPGLOBALSPEECHSTATE eGlobalSpeechState,
          [in] BSTR bstrTitle,
          [in] DWORD cWCISInfo,
          [in] EnumString * pEnumWCISInfo);
};
```

The dwCookie value is used as a unique identifier so stale information can be replaced, if necessary. The eGlobalSpeechState value indicates if this particular listener is active in a Commanding and/or Dictation mode. In one particular implementation, a listener is active when focus is on a Cicero-enabled application to indicate if some of the dictation commands are currently active.

The final three parameters (bstrTitle, cWCISInfo, pEnumWCISInfo) are used to display a category title in the WCIS user interface 148 (bstrTitle) and to retrieve the actual phrases to be displayed under this category (cWCISInfo and pEnumWCISInfo).

Speech Site Interface

The speech site interface 140 is implemented by the speech manager 134 and provides the listeners 128, 130 (in ISpDesktopListener::Init( )) a way in which to communicate back with the speech manager 134. An exemplary speech site interface 140 is shown and described below. The following discussion of the speech site interface 140 refers to the speech site interface 140 as (interface) ISpDesktopListenerSite 140. ISpDesktopListenerSite 140 is the nomenclature utilized in one or more versions of the WINDOWS family of operating systems provided by MICROSOFT CORP. Such a designation in the following discussion is for exemplary purposes only and is not intended to limit the platform described herein to a WINDOWS operating system

The following is an example of the ISpDesktopListenerSite 140 interface.

Interface ISpDesktopListenerSite

```
{
    HRESULT NotifyOnEvent(
        HANDLE hNotifyWhenSignaled,
        ISpNotifySink * pNotify);,
    HRESULT TextFeedback(
        TfLBBalloonStyle style,
        WCHAR * pszFeedback,
        ULONG cch);
};
```

The NotifyOnEvent method instructs the speech object 122 to call the notification sink when the hNotifyWhenSignaled handle is signaled. This allows the listeners 128, 130 to set up a notification callback mechanism without having to implement their own thread to monitor it. A “Program Launch” listener, for example, uses this to monitor for any changes in the file system (e.g., addition of new programs).

The TextFeedback method is used by the listeners 128, 130 to inform a user of pending actions. For example, a “Program Launch” listener uses this method to inform the user that it is about to launch an application. This is very useful in a case where starting up a new application takes some time and assures the user that an action was taken. The TfLBBalloonStyle method is used by a WINDOWS component (called Cicero) to communicate the text to any display object that is interested in this information. The pszFeedback and cch parameters are the feedback text and its length in count of characters respectively.

Additional information about speech system 100 is disclosed in U.S. Patent Application Publication No. 2003/0235818 entitled SPEECH PLATFORM ARCHITECURE, assigned to Microsoft Corporation of Redmond, Wash., USA, the disclosure of which is incorporated herein in its entirety.

FIG. 2 is a schematic illustration of an exemplary speech interaction system including an exemplary operating environment. This system 200 includes a display 202 having a screen 204, one or more user-input devices 206, and a computer 208.

The user-input devices 206 can include any device allowing a computer to receive a developer's input, such as a keyboard 210, other device(s) 212, and a mouse 214. The other device(s) 212 can include a touch screen, a voice-activated input device, a track ball, and any other device that allows the system 200 to receive input from a user. The computer 208 includes a processing unit 216 and random access memory and/or read-only memory 218. Memory 218 includes an operating system 220 for managing operations of computer 208 and one or more application programs, such as speech interaction module 222, speech interaction cancellation module 224, and other application modules 226. Memory 218 may further include XML data files 228 and an operation log 230. The computer 208 communicates with a user and/or a developer through the screen 204 and the user-input devices 206. Operation of the speech interaction cancellation module 224 is explained in greater detail below

Exemplary Operations

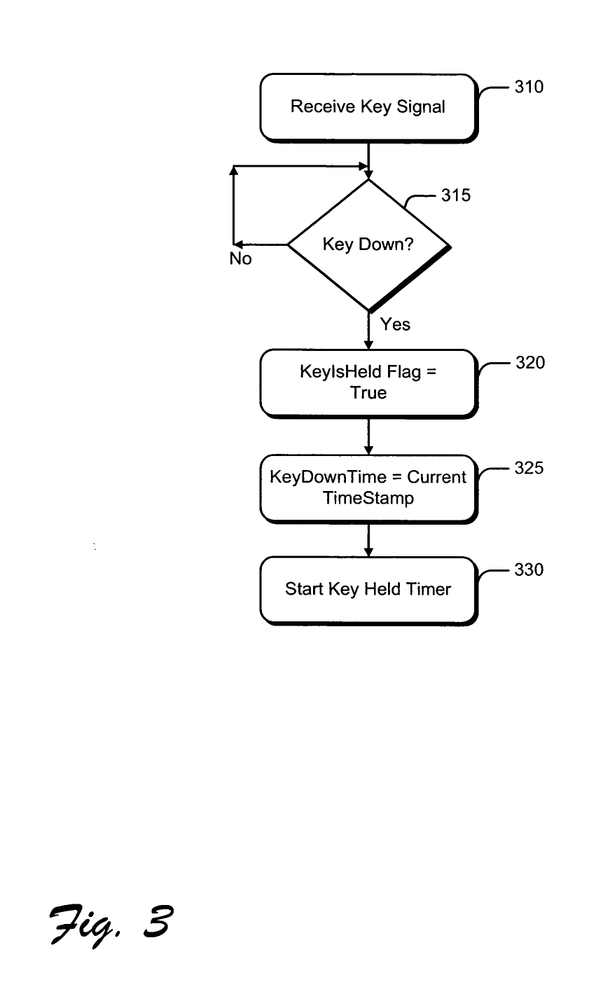

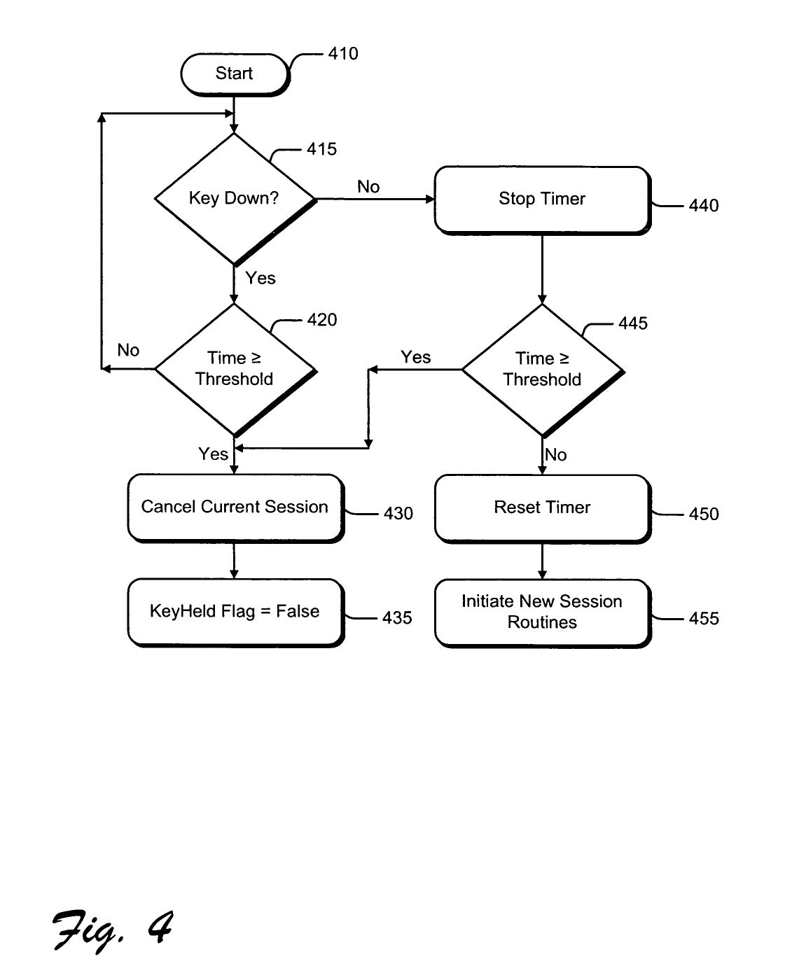

FIGS. 3-4 are flowcharts illustrating operations in an exemplary method for canceling a speech interaction session. In one implementation, a speech interaction session may be canceled by pressing and holding for a predetermined period of time a designated input device such as, e.g., a button, keyboard key, or other device. In one implementation the predetermined period of time measures between one and five seconds, although the specific length of time is not critical. From a functional perspective, the length of time should be sufficient to avoid inadvertent cancellations caused by a user accidentally pushing the button, yet not so long in duration as to cause inconvenience. In an exemplary implementation the operations of FIGS. 3-4 may be embodied in the speech interaction cancellation module 224, and executed by the processing unit 216 depicted in FIG. 2.

At operation 310 a key signal is received indicating the state of the input device. For the purposes of this description, the input device functions as a switch that can assume at least one of two logical states, i.e., pressed or not pressed. The key signal indicates the state of the input device. In a computer-based implementation, the key may be a key on the keyboard 210, a button on a mouse 214, or a button on another input device, or a “soft” button on a touch-screen, or a dialog button activated by a mouse click. The signal generated by the input device is passed to the operating system 220, which ultimately passes the signal to the speech interaction cancellation module 224.

At operation 315 the key signal is monitored to determine whether the input device, designated as a key in the drawing, is in the “down” position, i.e., whether the key or button is depressed. It will be appreciated that the designation of “down” is arbitrary, and based on conventional input device design in which buttons are normally biased in an “up” direction and are depressed by a user to generate a signal indicating that the input device has been activated. If the input device is not in the down position, then the speech interaction cancellation module implements a loop that monitors the state of the input device.

By contrast, if the input device is in the down position, then control passes to operation 320 and a flag is set indicating that the input device is being held, i.e., is in the down position. At operation 325 a timestamp reflecting the time at which the key was depressed is recorded. The timestamp may be stored in a suitable memory location in either volatile or non-volatile memory.

Optionally, at operation 330 a timer is started. Operation 330 is unnecessary in a computer system that has a system clock. In such a system recording the timestamp at operation 325 effectively starts a timer.

FIG. 4 is a flowchart illustrating further operations in an exemplary method for canceling a speech interaction session. The operations of FIG. 4 are implemented in sequence after the operations of FIG. 3. Operation begins at 410, and operations 415-420 implement a loop that monitors the logical state of the signal generated to determine if the key remains down for time period that is at least equal to a threshold. If the speech interaction cancellation module 224 starts a separate clock in operation 330, then the time reflected on the clock may be compared to a threshold. By contrast, if the speech interaction cancellation module 224 records a timestamp in operation 325, then the timestamp may be subtracted from the current system clock to determine the elapsed time, which may be compared to the threshold.

If the key remains down for a time period that exceeds the threshold, then control passes to operation 430 and the current speech interaction session is canceled. In an exemplary implementation canceling the speech interaction session includes canceling all operations executed by the user since the beginning of a session. For example, assume that the speech interaction module interacts with one or more application modules 226, which permit a user to manipulate one or more data files 228. Upon cancellation of the speech interaction session any changes made to the data files 228 are “undone”. This may be accomplished by maintaining an operation log 230 in the system memory 218 that records any changes made to data files 228 during the speech interaction session, and reversing the operations recorded in the log when a session is canceled. At operation 435 the keyheld flag is set to FALSE and operations of the speech interaction cancellation module 224 can terminate or return to the monitoring operations of FIG. 3.

Referring back to operation 415, if the key is not held in the down position for the time duration required to invoke cancellation operations 430-435, then control passes back to operation 415. If the key is not in the down position, then control passes to operation 440 and the timer is stopped. Operation 445 implements a redundant check to determine if the key remained down for a time period that exceeds the threshold and if so then control passes to operations 430-435 and the current speech interaction session is canceled.

By contrast, if at operation 445 the time period for which the key was down did not exceed the threshold, then control passes to optional operation 450 and the timer is reset. If the system clock is used then operation 445 is unnecessary because the timestamp will be reset in subsequent operation. At operation 455 a new speech interaction session may be initiated.

The operations of FIGS. 3-4 may be implemented by the speech interaction cancellation module 224, e.g., as a background process that monitors the input device(s) for signals indicating a user's desire to cancel a speech interaction session.

In alternate implementations the operations of FIGS. 3-4 may be modified to terminate a speech interaction session by manipulating an input device in different manners. In one alternate implementation a speech interaction session may be terminated by double-pressing a specified input device such as, e.g., a key or a button. In this embodiment, rather than monitoring for an input that exceeds a specific time duration the speech interaction cancellation module 224 monitors for three distinct input states (i.e., down-up-down) in a predetermined time period. In yet another implementation a speech interaction session may be terminated by pressing a specified sequence of different buttons. In this implementation the speech interaction cancellation module 224 monitors for a predetermined sequence of input states from one or more different input devices.

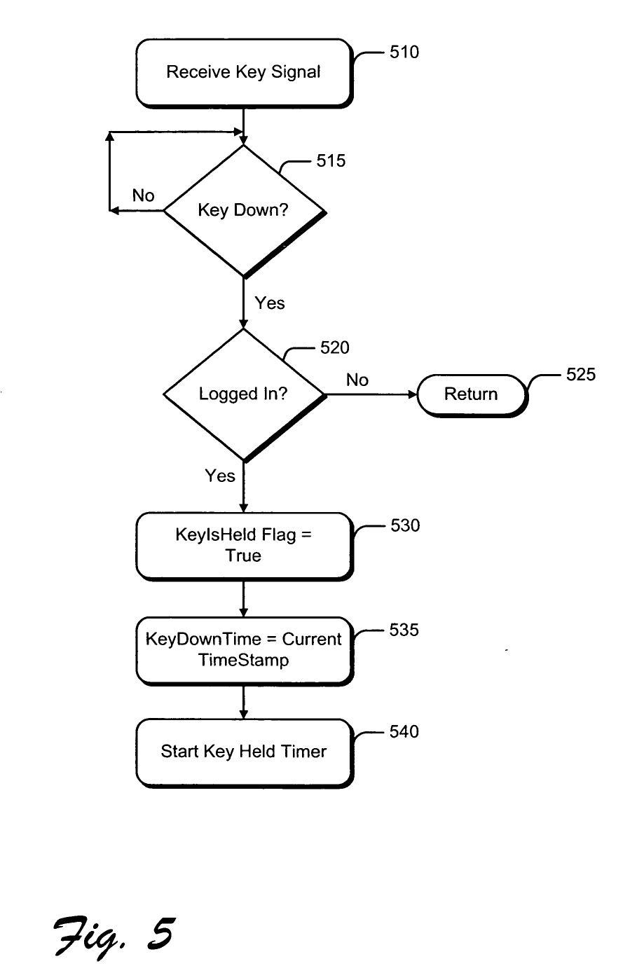

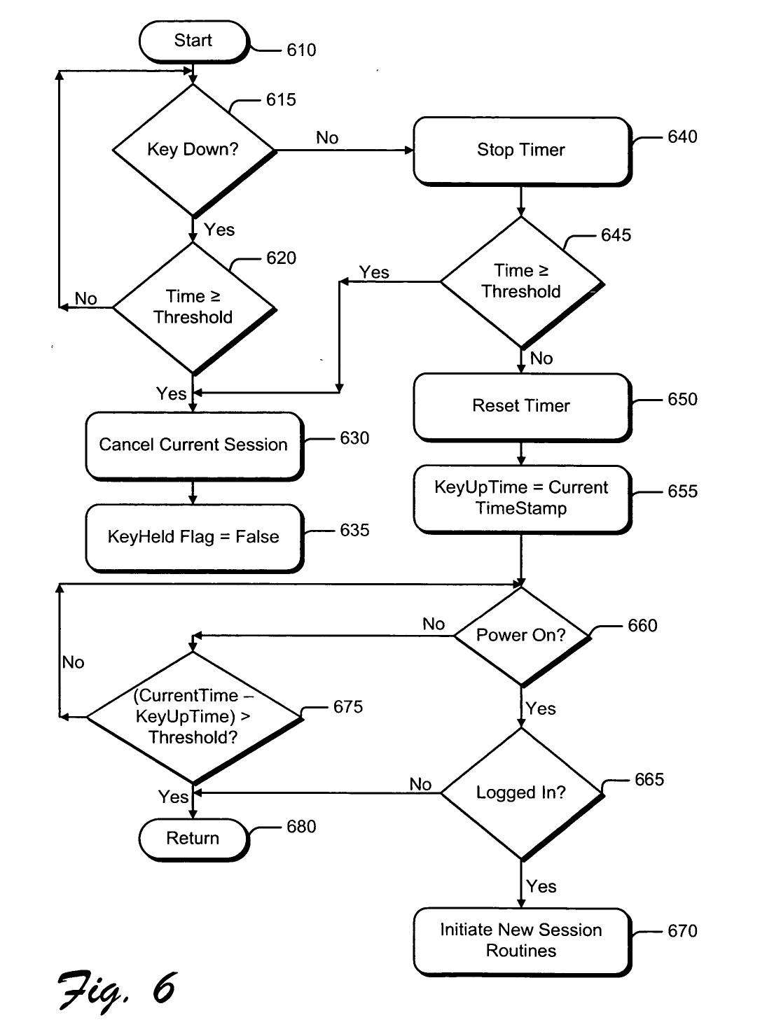

FIGS. 5-6 are flowcharts illustrating operations in another exemplary method for canceling a speech interaction session. The operations illustrated in FIGS. 5-6 may find particular application in conjunction with processing devices and/or applications that require users to log in to the device and/or applications, or that provide a standby operational mode. Exemplary devices include personal digital assistants (PDAs) or other electronic devices that implement a power-saving standby mode. In an exemplary implementation the operations of FIGS. 5-6 may be embodied in the speech interaction cancellation module 224, and executed by the processing unit 216 depicted in FIG. 2.

At operation 510 a key signal is received indicating the state of the input device. For the purposes of this description, the input device functions as a switch that can assume at least one of two logical states, i.e., pressed or not pressed. The key signal indicates the state of the input device. In a computer-based implementation, the key may be a key on the keyboard 210, a button on a mouse 214, or a button on another input device, or a “soft” button on a touch-screen, or a dialog button activated by a mouse click. The signal generated by the input device is passed to the operating system 220, which ultimately passes the signal to the speech interaction cancellation module 224.

At operation 515 the key signal is monitored to determine whether the input device, designated as a key in the drawing, is in the “down” position, i.e., whether the key or button is depressed. It will be appreciated that the designation of “down” is arbitrary, and based on conventional input device design in which buttons are normally biased in an “up” direction and are depressed by a user to generate a signal indicating that the input device has been activated. If the input device is not in the down position, then the speech interaction cancellation module implements a loop that monitors the state of the input device.

By contrast, if the input device is in the down position, then control passes to operation 520 and it is determined whether the user is logged into the device and/or application. In an exemplary implementation this may be determined by setting a flag to a specific value when the user logs into the device and/or application. This flag may then be checked to determine whether the value of the flag indicates that the user is logged in to the device and/or application. If, at operation 520, the user is not logged in then control passes to operation 525 and control returns to the calling routine.

By contrast, if at operation 520 the user is logged into the device and/or application, then control passes to operation 530 and a flag is set indicating that the input device is being held, i.e., is in the down position. At operation 535 a timestamp reflecting the time at which the key was depressed is recorded. The timestamp may be stored in a suitable memory location in either volatile or non-volatile memory.

Optionally, at operation 540 a timer is started. Operation 540 is unnecessary in a computer system that has a system clock. In such a system recording the timestamp at operation 535 effectively starts a timer.

FIG. 6 is a flowchart illustrating further operations in an exemplary method for canceling a speech interaction session. The operations of FIG. 6 are implemented in sequence after the operations of FIG. 5. Operation 610-655 are analogous to operations 410-445, and the reader is referred to these operations for an explanation of analogous operations 610-655.

In an implementation adapted for a device and/or application that implements log-in procedures and/or a standby mode, following operation 655 a test is implemented at operation 660 to determine whether the device is in the power on state, as opposed to a standby state. If the device is in the power-on state then control passes to operation 665, and it is determined whether the user is logged into the device and/or application. If the user is logged in, then control passes to operation 670 and new session routines are initiated.

By contrast, if at operation 660 the device is not in a power-on state, then control passes to operation 675, and a test is implemented to determine whether the time period between the key release and the current time exceeds a threshold for the device remaining in the power-on state without key activity. If the elapsed time exceeds this threshold, the device has slipped into a standby state, and control returns to the calling routine at operation 680. By contrast, if the threshold is not exceeded, then control may pass back to operation 660.

The operations of FIGS. 5-6 may be implemented by the speech interaction cancellation module 224, e.g., as a background process that monitors the input device(s) for signals indicating a user's desired to cancel a speech interaction session.

In alternate implementations the operations of FIGS. 5-6 may be modified to terminate a speech interaction session by manipulating an input device in different manners. In one alternate implementation a speech interaction session may be terminated by double-pressing a specified input device such as, e.g., a key or a button. In this embodiment, rather than monitoring for an input that exceeds a specific time duration the speech interaction cancellation module 224 monitors for three distinct input states (i.e., down-up-down) in a predetermined time period. In yet another implementation a speech interaction session may be terminated by pressing a specified sequence of different buttons. In this implementation the speech interaction cancellation module 224 monitors for a predetermined sequence of input states from one or more different input devices.

Exemplary Computer Environment

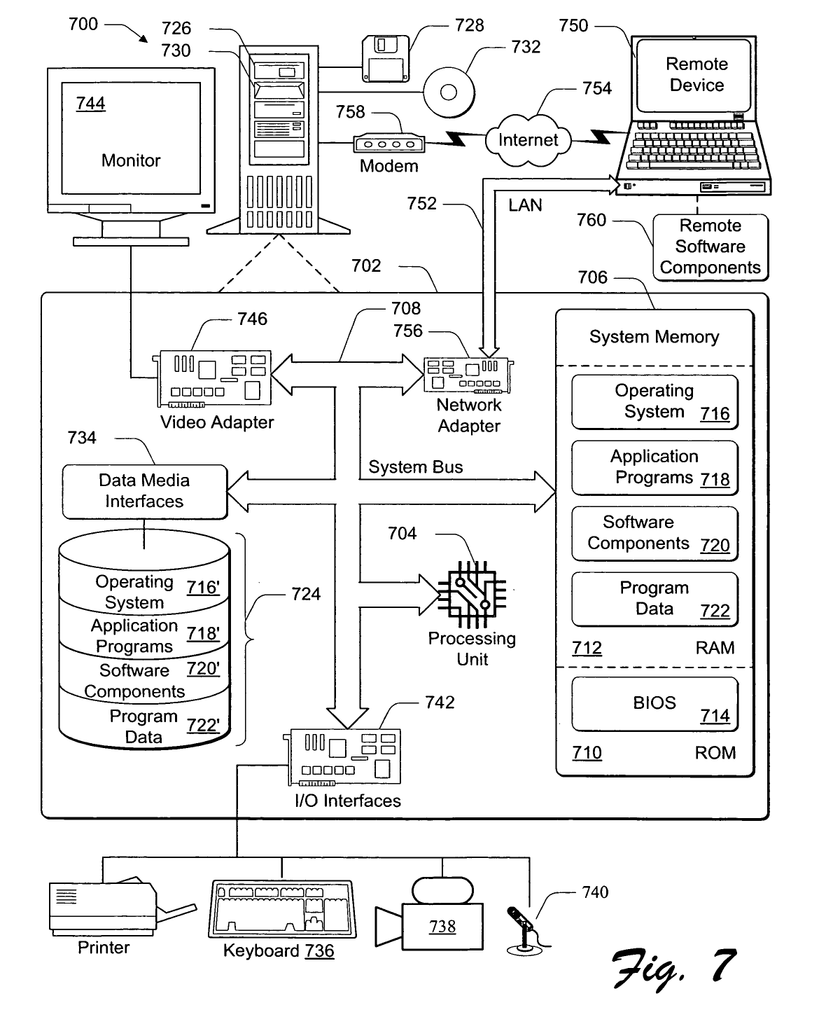

The various components and functionality described herein are implemented with a number of individual computers. FIG. 7 shows components of typical example of such a computer, referred by to reference numeral 700. The components shown in FIG. 7 are only examples, and are not intended to suggest any limitation as to the scope of the functionality of the invention; the invention is not necessarily dependent on the features shown in FIG. 7.

Generally, various different general purpose or special purpose computing system configurations can be used. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The functionality of the computers is embodied in many cases by computer-executable instructions, such as program modules, that are executed by the computers. Generally, program modules include routines, programs, objects, components, data structures, etc. that perform particular tasks or implement particular abstract data types. Tasks might also be performed by remote processing devices that are linked through a communications network. In a distributed computing environment, program modules may be located in both local and remote computer storage media.

The instructions and/or program modules are stored at different times in the various computer-readable media that are either part of the computer or that can be read by the computer. Programs are typically distributed, for example, on floppy disks, CD-ROMs, DVD, or some form of communication media such as a modulated signal. From there, they are installed or loaded into the secondary memory of a computer. At execution, they are loaded at least partially into the computer's primary electronic memory. The invention described herein includes these and other various types of computer-readable media when such media contain instructions programs, and/or modules for implementing the steps described below in conjunction with a microprocessor or other data processors. The invention also includes the computer itself when programmed according to the methods and techniques described below.

For purposes of illustration, programs and other executable program components such as the operating system are illustrated herein as discrete blocks, although it is recognized that such programs and components reside at various times in different storage components of the computer, and are executed by the data processor(s) of the computer.

With reference to FIG. 7, the components of computer 700 may include, but are not limited to, a processing unit 704, a system memory 706, and a system bus 708 that couples various system components including the system memory to the processing unit 704. The system bus 708 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISAA) bus, Video Electronics Standards Association (VESA) local bus, and Peripheral Component Interconnect (PCI) bus also known as the Mezzanine bus.

Computer 700 typically includes a variety of computer-readable media. Computer-readable media can be any available media that can be accessed by computer 700 and includes both volatile and nonvolatile media, removable and non-removable media. By way of example, and not limitation, computer-readable media may comprise computer storage media and communication media. “Computer storage media” includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 700. Communication media typically embodies computer-readable instructions, data structures, program modules or other data in a modulated data signal such as a carrier wave or other transport mechanism and includes any information delivery media. The term “modulated data signal” means a signal that has one or more if its characteristics set or changed in such a manner as to encode information in the signal. By way of example, and not limitation, communication media includes wired media such as a wired network or direct-wired connection and wireless media such as acoustic, RF, infrared and other wireless media. Combinations of any of the above should also be included within the scope of computer readable media.

The system memory 706 includes computer storage media in the form of volatile and/or nonvolatile memory such as read only memory (ROM) 710 and random access memory (RAM) 712. A basic input/output system 714 (BIOS), containing the basic routines that help to transfer information between elements within computer 700, such as during start-up, is typically stored in ROM 710. RAM 712 typically contains data and/or program modules that are immediately accessible to and/or presently being operated on by processing unit 704. By way of example, and not limitation, FIG. 7 illustrates operating system 716, application programs 718, other program modules 720, and program data 722.

The computer 700 may also include other removable/non-removable, volatile/nonvolatile computer storage media. By way of example only, FIG. 7 illustrates a hard disk drive 724 that reads from or writes to non-removable, nonvolatile magnetic media, a magnetic disk drive 726 that reads from or writes to a removable, nonvolatile magnetic disk 728, and an optical disk drive 730 that reads from or writes to a removable, nonvolatile optical disk 732 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 724 is typically connected to the system bus 708 through a non-removable memory interface such as data media interface 734, and magnetic disk drive 726 and optical disk drive 730 are typically connected to the system bus 708 by a removable memory interface 734.

The drives and their associated computer storage media discussed above and illustrated in FIG. 7 provide storage of computer-readable instructions, data structures, program modules, and other data for computer 700. In FIG. 7, for example, hard disk drive 724 is illustrated as storing operating system 716′, application programs 718′, other program modules 720′, and program data 722′. Note that these components can either be the same as or different from operating system 716, application programs 718, other program modules 720, and program data 722. Operating system 716, application programs 718, other program modules 720, and program data 722 are given different numbers here to illustrate that, at a minimum, they are different copies. A user may enter commands and information into the computer 700 through input devices such as a keyboard 736, a mouse, trackball, or touch pad. Other input devices (not shown) may include a microphone, joystick, game pad, satellite dish, scanner, or the like. These and other input devices are often connected to the processing unit 704 through an input/output (I/O) interface 742 that is coupled to the system bus, but may be connected by other interface and bus structures, such as a parallel port, game port, or a universal serial bus (USB). A monitor 744 or other type of display device is also connected to the system bus 708 via an interface, such as a video adapter 746. In addition to the monitor 744, computers may also include other peripheral output devices (e.g., speakers) and one or more printers, which may be connected through the I/O interface 742.

The computer may operate in a networked environment using logical connections to one or more remote computers, such as a remote computing device 750. The remote computing device 750 may be a personal computer, a server, a router, a network PC, a peer device or other common network node, and typically includes many or all of the elements described above relative to computer 700. The logical connections depicted in FIG. 7 include a local area network (LAN) 752 and a wide area network (WAN) 754. Although the WAN 754 shown in FIG. 7 is the Internet, the WAN 754 may also include other networks. Such networking environments are commonplace in offices, enterprise-wide computer networks, intranets, and the like.

When used in a LAN networking environment, the computer 700 is connected to the LAN 752 through a network interface or adapter 756. When used in a WAN networking environment, the computer 700 typically includes a modem 758 or other means for establishing communications over the Internet 754. The modem 758, which may be internal or external, may be connected to the system bus 708 via the I/O interface 742, or other appropriate mechanism. In a networked environment, program modules depicted relative to the computer 700, or portions thereof, may be stored in the remote computing device 750. By way of example, and not limitation, FIG. 7 illustrates remote application programs 760 as residing on remote computing device 750. It will be appreciated that the network connections shown are exemplary and other means of establishing a communications link between the computers may be used.

### CONCLUSION

Although the described arrangements and procedures have been described in language specific to structural features and/or methodological operations, it is to be understood that the subject matter defined in the appended claims is not necessarily limited to the specific features or operations described. Rather, the specific features and operations are disclosed as preferred forms of implementing the claimed present subject matter.

1. A method of canceling a speech interaction session, comprising:
receiving a signal indicating that a predetermined switch has been set to a first state;
monitoring a time parameter indicative of a time the switch remains in the first state; and
canceling the speech interaction session if the time parameter exceeds a threshold.

2. The method of claim 1, wherein monitoring a time parameter indicative of a time the switch remains in the first state comprises starting a timer in response to the signal.

3. The method of claim 2, further comprising:
setting a flag indicating that the switch is in the first state; and
recording a time stamp indicative of a time at which the signal is received.

4. The method of claim 3, wherein the time stamp corresponds to a signal clock time.

5. The method of claim 3, wherein canceling the speech interaction session if the time parameter exceeds a threshold comprises:
monitoring a state of the switch; and
canceling the speech interaction session if a result of subtracting the time stamp from a current system time exceeds a threshold.

6. The method of claim 5, wherein canceling the speech interaction session comprises reversing any operations performed during the speech interaction session.

7. The method of claim 1, wherein monitoring a time parameter indicative of the time the switch remains in the first state comprises:
monitoring a state of the switch; and
invoking a new speech interaction session if the state of the switch changes from a first state to a second state before the time parameter exceeds a threshold.

8. The method of claim 1, further comprising resetting a timer if a state of the switch changes from a first state to a second state before the time parameter exceeds a threshold.

9. The method of claim 1, further comprising initiating a new speech interaction session if the time parameter does not exceed a threshold.

10. The method of claim 9, further comprising determining whether a device is in a power on state and whether a user is logged into the device.

11. One or more computer-readable media comprising logic instructions which, when executed by a processor, configure the processor to:
start a timer in response to a received signal indicating that a predetermined switch has been set to a first state;
monitor a state of the switch; and
cancel a speech interaction session if a time parameter exceeds a threshold.

12. The one or more computer-readable media of claim 11, further comprising logic instructions which, when executed by a processor, configure the processor to:
set a flag indicating that the switch is in the first state; and
record a time stamp indicative of the time at which the signal is received.

13. The one or more computer-readable media of claim 11, further comprising logic instructions which, when executed by a processor, configure the processor to cancel the speech interaction session if a result of subtracting the time stamp from a current system time exceeds a threshold.

14. The one or more computer-readable media of claim 13, further comprising logic instructions which, when executed by a processor, configure the processor to reverse any operations performed during the speech interaction session.

15. The one or more computer-readable media of claim 11, further comprising logic instructions which, when executed by a processor, configure the processor to invoke a new speech interaction session if a state of the switch changes from a first state to a second state before the time parameter exceeds a threshold.

16. The one or more computer-readable media of claim 11, further comprising logic instructions which, when executed by a processor, configure the processor to reset a timer if a state of the switch changes from a first state to a second state before the time parameter exceeds a threshold.

17. The one or more computer-readable media of claim 11, wherein the one or more computer-readable media comprises at least one of an electronic memory module, a magnetic memory module, and an optical memory module.

18. The one or more computer-readable media of claim 11, further comprising logic instructions which, when executed by a processor, configure the processor to initiate a new speech interaction session if the time parameter does not exceed a threshold.

19. The one or more computer-readable media of claim 11, further comprising logic instructions which, when executed by a processor, configure the processor to determine whether a device is in a power on state and whether a user is logged into the device.

20. A system, comprising:
a processing unit;
one or more input devices communicatively connected to the processor for generating one or more input signals;
a memory module associated with the processor, the memory module comprising:
a speech interaction module for receiving spoken commands from a user and generating computer-executable instructions from the spoken commands; and
a speech interaction cancellation module for receiving an input signal from the one or more input devices and terminating a speech interaction session in response to the input signal.
